(19) United States
(12) Patent Application Publication
(10) Pub. No.: US 2011/0313072 A1
(43) Pub. Date: Dec. 22, 2011

(54) METHOD FOR MANUFACTURING A PLURALITY OF SHAPED FOAM ARTICLES

(76) Inventors: Myron J. Maurer, Saginaw, MI (US); Casey R. Fiting, Freeland, MI (US); Matthew D. Mittag, Midland, MI (US); Alain M. Sagnard, Drusenheim (FR)

(21) Appl. No.: 13/148,330

(22) PCT Filed: Jan. 29, 2010
(86) PCT No.: PCT/US10/22464

§ 371 Date: Aug. 8, 2011

Related U.S. Application Data
(60) Provisional application No. 61/152,415, filed on Feb. 13, 2009.

(51) Int. Cl. C08F 114/00; B29C 44/56

(52) U.S. Cl. 521/146; 264/48

(57) ABSTRACT

The present invention is a method to manufacture one or more shaped foam article. Specifically, the present invention is a method of extruding a thermoplastic polymer with a blowing agent to form a foam polymer plank having a density gradient. Preferably, shaped articles are prepared from the surface of the foam plank having the lowest density. The article is shaped by a mold comprising one or a plurality of cavities wherein the periphery of each cavity is defined by a trimming rib, said mold concurrently shapes the foam article and trims the resulting shaped foam article from the surrounding continuous unshaped foam plank. Preferably, the foam has a vertical compressive balance (Rv) equal to or greater than 0.4 and more preferably, the foam has a cell gas pressure less than 1 atmosphere and/or an open cell content of equal to or less than 20 percent.

### CROSS REFERENCE STATEMENT

This application claims the benefit of U.S. Provisional Application No. 61/152,415 filed Feb. 13, 2009.

### BACKGROUND OF THE INVENTION

The invention relates to an improved method of shaping and trimming an extruded thermoplastic foam, preferably a polystyrene foam, into one or more shaped foam article.

Various methods and techniques are currently known and employed in the industry for shaping and trimming a plurality of shaped articles from a sheet of thermoplastic foam material. For example, articles such as dishes, cups, egg cartons, trays, various types of containers, e.g., fast food clam shells, take out/take home containers, and the like made from foamed plastic. In many instances, the articles are produced via a two-step process. In one such process, the first step comprises thermoforming articles in a first forming station, side-by-side or in a tandem relationship in a foam sheet, through cooperating male and female molding dies. In the second step, the entire thermoplastic foam sheet material together with the molded articles is conveyed to a separate trimming station in which the molded articles are separated from the remaining sheet material by a trimming procedure implemented through the employment of suitable trimming cutters or blades, for example see U.S. Pat. No. 4,313,358. In an alternative two-step process, the thermoplastic sheet is first cut providing a pre-form which is then shaped into a shaped foam article, for example see U.S. Pat. No. 5,939,009. However, these processes are limited to relatively thin articles, for example less than 10 millimeters, having non-complex shapes, i.e., simple curves and/or symmetrical designs. Further, two-step processes raise the cost to manufacture a shaped foamed article because they are time consuming: (1) there is a long cycle time resulting from heating the foam thermoplastic sheet prior to molding then cooling it afterwards and (2) because the molding step and the trimming step are performed separately. Moreover, two-step processes are costly because they require multiple apparatuses, e.g., the molding machine and the trimming equipment.

Several alternatives have been devised to improve the foregoing. For example, a more cost effective method has been developed wherein shaped thermoplastic articles are trimmed in place. In other words, the shaped thermoplastic articles are formed and separated from the remaining sheet in a single step, for examples see U.S. Pat. Nos. 4,755,129 and 4,526,074. However, these methods suffer from one or more of the other above-mentioned limitations. In addition, the cutting blades which are typically thin (about 0.003 to 0.025 inches) tempered steel with sharply-pointed toothed or serrated edges are subjected to extensive wear during continual and repetitive utilization, thereby rendering such apparatus uneconomical.

Cold-forming foam sheet (i.e., where the foam is not heated but the molds are) has been disclosed in U.S. Pat. No. 5,219,893. This can decrease molding cycle times by eliminating the steps of heating the foam sheet prior to molding and cooling afterwards. However, in addition to suffering from one or more of the other abovementioned limitations, this method is limited to a very specific open-celled, rigid polyurethane foam composition of relatively thin thickness, e.g., 1 centimeter.

Accordingly, it would be desirable to provide a shaping and trimming method for thermoplastic foam sheet, preferably polystyrene foam sheet, which provides shaped and trimmed foam articles and in particular thicker shaped foam articles with controlled dimensions. Preferably, the process would not require the foam to be heated prior to and cooled after shaping and would not require a multi-step mold/trim process.

### SUMMARY OF THE INVENTION

The present invention is such a simple, cost effective method to shape and trim one or more article from foam sheet. The method to prepare shaped foam articles of the present invention eliminates the need for separate molding and trimming equipment, heating and cooling the foam, improved dimensional control in the shaped foam article, and importantly, is capable of shaping and trimming thicker thermoplastic foam sheet. The method of the present invention can reduce capital, decrease cycle time, and extend the lifetime for trimming means as compared to methods known in the art.

In one embodiment, the present invention is a method to manufacture one or more shaped foam article comprising the steps of (i) extruding a thermoplastic polymer with a blowing agent to form a thermoplastic polymer foam plank, the plank having a top and a bottom surface in which said surfaces lie in the plane defined by the direction of extrusion and the width of the plank, wherein the foam plank has a vertical compressive balance equal to or greater than 0.4 and one or more pressing surface and (ii) concurrently shaping and trimming the one or more pressing surface of the foam plank into one or more shaped foamed article and surrounding continuous unshaped foam plank by contacting the pressing surface of the foam plank with a mold, said mold comprising one or a plurality of cavities wherein the periphery of each cavity is defined by a trimming rib, and pressing the foam plank with the mold whereby forming one or more shaped foam article and trimming each shaped foam article thus formed from the surrounding continuous unshaped foam plank.

Preferably, the pressing surface is created by the step of removing a layer of foam from the top surface, the bottom surface, or both the top and bottom surfaces and/or cutting the foam plank between the top and the bottom surfaces creating two pressing surfaces opposite the top and bottom surfaces.

In one embodiment, the thermoplastic foam plank is prepared by extrusion using a chemical blowing agent, an inorganic gas, preferably carbon dioxide, an organic blowing agent, or combinations thereof, wherein the thermoplastic polymer is preferably polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyvinyl chloride; polyphenylene oxide and polystyrene blend.

In one embodiment, the foam has a cell gas pressure equal to or less than 1 atmosphere.

In one embodiment the foam plank is at ambient temperature during the shaping step.

In one embodiment the present invention is a shaped foam article made by the method described hereinabove, such as foam trim, automotive parts, decorative insulation, safety equipment, packaging material, formfit insulation, siding, insulated sheathing, insulated building cladding, decorative trim, vinyl siding backing, integrated radiant floor heating panel, sandwich panel with non-planer faces, composite panel, foot wear, buoyancy part for boats or watercraft, decoration product for a craft application, an energy absorption component in a helmet, an energy absorption component in a military application, an energy absorption component in an automotive article, foam composite parts for windmill turbine blades, composite roof tiles, or a cushion packaging article.

In yet another embodiment of the present invention a shaped foam article with one or more through feature is made by the method descried hereinabove.

### BRIEF DESCRIPTION OF THE DRAWINGS

FIG. 1 is a standard cell pressure vs. aging curve for three foamed polystyrene planks.

FIG. 2 is a cross-sectional view of a forming tool with trimming rib in the open position.

FIG. 3 is a cross-sectional view of a forming tool with trimming rib in the closed position.

FIG. 4 is an illustration of the step change in the shaped foam article of this invention.

FIG. 5 is a reproduction of a photograph of a shaped foam article manufactured by the process of the present invention.

FIG. 6 is a reproduction of a photograph of a shaped foam article not manufactured by the process of the present invention.

### DETAILED DESCRIPTION OF THE INVENTION

The foamed article of the present invention is made from a foam composition. A foam composition comprises a continuous matrix material with cells defined therein. Cellular (foam) has the meaning commonly understood in the art in which a polymer has a substantially lowered apparent density comprised of cells that are closed or open. Closed cell means that the gas within that cell is isolated from another cell by the polymer walls forming the cell. Open cell means that the gas in that cell is not so restricted and is able to flow without passing through any polymer cell walls to the atmosphere. The foam article of the present invention can be open or closed celled. A closed cell foam has less than 30 percent, preferably 25 percent or less, more preferably 20 percent or less and still more preferably 10 percent or less and most preferably 5 percent or less open cell content. A closed cell foam can have zero percent open cell content. Conversely, an open cell foam has 30 percent or more, preferably 50 percent or more, still more preferably 70 percent or more, yet more preferably 90 percent or more open cell content. An open cell foam can have 95 percent or more and even 100 percent open cell content. Unless otherwise noted, open cell content is determined according to American Society for Testing and Materials (ASTM) method D6226-05.

Desirably the foam article comprises polymeric foam, which is a foam composition with a polymeric continuous matrix material (polymer matrix material). Any polymeric foam is suitable including extruded polymeric foam, expanded polymeric foam and molded polymeric foam. The polymeric foam can comprise, and desirably comprises as a continuous phase, a thermoplastic or a thermoset polymer matrix material. Desirably, the polymer matrix material has a thermoplastic polymer continuous phase.

A polymeric foam article for use in the present invention can comprise or consist of one or more thermoset polymer, thermoplastic polymer, or combinations or blends thereof. Suitable thermoset polymers include thermoset epoxy foams, phenolic foams, urea-formaldehyde foams, polyurethane foams, and the like.

Suitable thermoplastic polymers include any one or any combination of more than one thermoplastic polymer. Olefinic polymers, alkenyl-aromatic homopolymers and copolymers comprising both olefinic and alkenyl aromatic components are suitable. Examples of suitable olefinic polymers include homopolymers and copolymers of ethylene and propylene (e.g., polyethylene, polypropylene, and copolymers of polyethylene and polypropylene). Alkenyl-aromatic polymers such as polystyrene and polyphenylene oxide/polystyrene blends are particularly suitable polymers for of the foam article of the present invention.

Desirably, the foam article comprises a polymeric foam having a polymer matrix comprising or consisting of one or more than one alkenyl-aromatic polymer. An alkenyl-aromatic polymer is a polymer containing alkenyl aromatic monomers polymerized into the polymer structure. Alkenyl-aromatic polymer can be homopolymers, copolymers or blends of homopolymers and copolymers. Alkenyl-aromatic copolymers can be random copolymers, alternating copolymers, block copolymers, rubber modified, or any combination thereof and my be linear, branched or a mixture thereof.

Styrenic polymers are particularly desirably alkenyl-aromatic polymers. Styrenic polymers have styrene and/or substituted styrene monomer (e.g., alpha methyl styrene) polymerized in the polymer backbone and include both styrene homopolymer, copolymer and blends thereof. Polystyrene and high impact modified polystyrene are two preferred styrenic polymers.

Examples of styrenic copolymers suitable for the present invention include copolymers of styrene with one or more of the following: acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

Polystyrene (PS) is a preferred styrenic polymer for use in the foam articles of the present invention because of its good balance between cost and property performance.

Styrene-acrylonitrile copolymer (SAN) is a particularly desirable alkenyl-aromatic polymer for use in the foam articles of the present invention because of its ease of manufacture and monomer availability. SAN copolymer can be a block copolymer or a random copolymer, and can be linear or branched. SAN provides higher water solubility than polystyrene homopolymer, thereby facilitating use of an aqueous blowing agent. SAN also has higher heat distortion temperature than polystyrene homopolymer, which provides for foam having a higher use temperature than polystyrene homopolymer foam. Desirable embodiments of the present process employ polymer compositions that comprise, even consist of SAN. The one or more alkenyl-aromatic polymer, even the polymer composition itself may comprise or consist of a polymer blend of SAN with another polymer such as polystyrene homopolymer.

Whether the polymer composition contains only SAN, or SAN with other polymers, the acrylonitrile (AN) component of the SAN is desirably present at a concentration of 1 weight percent or more, preferably 5 weight percent or more, more preferably 10 weight percent or more based on the weight of all polymers in the polymer composition. The AN component of the SAN is desirably present at a concentration of 50 weight percent or less, typically 30 weight percent or less based on the weight of all polymers in the polymer composition. When AN is present at a concentration of less than 1 weight percent, the water solubility improvement is minimal over polystyrene unless another hydrophilic component is present. When AN is present at a concentration greater than 50 weight percent, the polymer composition tends to suffer from thermal instability while in a melt phase in an extruder.

The styrenic polymer may be of any useful weight average molecular weight (MW). Illustratively, the molecular weight of a styrenic polymer or styrenic copolymer may be from 10,000 to 1,000,000. The molecular weight of a styrenic polymer is desirably less than about 200,000, which surprisingly aids in forming a shaped foam part retaining excellent surface finish and dimensional control. In ascending further preference, the molecular weight of a styrenic polymer or styrenic copolymer is less than about 190,000, 180,000, 175,000, 170,000, 165,000, 160,000, 155,000, 150,000, 145,000, 140,000, 135,000, 130,000, 125,000, 120,000, 115,000, 110,000, 105,000, 100,000, 95,000, and 90,000. For clarity, molecular weight herein is reported as weight average molecular weight unless explicitly stated otherwise. The molecular weight may be determined by any suitable method such as those known in the art.

Rubber modified homopolymers and copolymers of styrenic polymers are preferred styrenic polymers for use in the foam articles of the present invention, particularly when improved impact is desired. Such polymers include the rubber modified homopolymers and copolymers of styrene or alpha-methylstyrene with a copolymerizable comonomer. Preferred comonomers include acrylonitrile which may be employed alone or in combination with other comonomers particularly methylmethacrylate, methacrylonitrile, fumaronitrile and/or an N-arylmaleimide such as N-phenylmaleimide. Highly preferred copolymers contain from about 70 to about 80 percent styrene monomer and 30 to 20 percent acrylonitrile monomer.

Suitable rubbers include the well known homopolymers and copolymers of conjugated dienes, particularly butadiene, as well as other rubbery polymers such as olefin polymers, particularly copolymers of ethylene, propylene and optionally a nonconjugated diene, or acrylate rubbers, particularly homopolymers and copolymers of alkyl acrylates having from 4 to 6 carbons in the alkyl group. In addition, mixtures of the foregoing rubbery polymers may be employed if desired. Preferred rubbers are homopolymers of butadiene and copolymers thereof in an amount equal to or greater than about 5 weight percent, preferably equal to or greater than about 7 weight percent, more preferably equal to or greater than about 10 weight percent and even more preferably equal to or greater than 12 weight percent based on the total weight or the rubber modified styrenic polymer. Preferred rubbers present in an amount equal to or less than about 30 weight percent, preferably equal to or less than about 25 weight percent, more preferably equal to or less than about 20 weight percent and even more preferably equal to or less than 15 weight percent based on the total weight or the rubber modified styrenic polymer. Such rubber copolymers may be random or block copolymers and in addition may be hydrogenated to remove residual unsaturation.

The rubber modified homopolymers or copolymers are preferably prepared by a graft generating process such as by a bulk or solution polymerization or an emulsion polymerization of the copolymer in the presence of the rubbery polymer. Depending on the desired properties of the foam article, the rubbers' particle size may be large (for example greater than 2 micron) or small (for example less than 2 micron) and may be a monomodal average size or multimodal, i.e., mixtures of different size rubber particle sizes, for instance a mixture of large and small rubber particles. In the rubber grafting process various amounts of an ungrafted matrix of the homopolymer or copolymer are also formed. In the solution or bulk polymerization of a rubber modified (co)polymer of a vinyl aromatic monomer, a matrix (co)polymer is formed. The matrix further contains rubber particles having (co)polymer grafted thereto and occluded therein.

High impact poly styrene (HIPS) is a particularly desirable rubber-modified alkenyl-aromatic homopolymer for use in the foam articles of the present invention because of its good blend of cost and performance properties, requiring improved impact strength.

Butadiene, acrylonitrile, and styrene (ABS) terpolymer is a particularly desirable rubber-modified alkenyl-aromatic copolymer for use in the foam articles of the present invention because of its good blend of cost and performance properties, requiring improved impact strength and improved thermal properties.

Foam articles for use in the present invention may be prepared from a foam plank prepared by any known process. A preferred process is an extrusion process wherein a foamable polymer composition of a thermoplastic polymer with a blowing agent is extruded by using an extruder by heating a thermoplastic polymer composition to soften it, mixing a blowing agent composition together with the softened thermoplastic polymer composition at a mixing temperature and mixing pressure that precludes expansion of the blowing agent to any meaningful extent (preferably, that precludes any blowing agent expansion) and then extruding (expelling) the foamable polymer composition through a die into an environment having a temperature and pressure below the mixing temperature and pressure. Upon expelling the foamable polymer composition into the lower pressure the blowing agent expands the thermoplastic polymer into a thermoplastic polymer foam. Desirably, the foamable polymer composition is cooled after mixing and prior to expelling it through the die. In a continuous process, the foamable polymer composition is expelled at an essentially constant rate into the lower pressure to enable essentially continuous foaming wherein the extruded foam plank can be a continuous, seamless foam plank. For example, a method for extruding styrenic foams such as described in U.S. Pat. Nos. 3,231,524; 3,482,006; 4,420,448; and 5,340,844 may be used.

Suitable blowing agents include one or any combination of more than one of the following: water, inorganic gases such as carbon dioxide, argon, nitrogen, and air; organic blowing agents such as aliphatic and cyclic hydrocarbons having from one to nine carbons including methane, ethane, propane, n-butane, isobutane, n-pentane, isopentane, neopentane, cyclobutane, and cyclopentane; fully and partially halogenated alkanes and alkenes having from one to five carbons, preferably that are chlorine-free (e.g., difluoromethane (HFC-32), perfluoromethane, ethyl fluoride (HFC-161), 1,1,-difluoroethane (HFC-152a), 1,1,1-trifluoroethane (HFC-143a), 1,1,2,2-tetrafluoroethane (HFC-134), 1,1,1,2 tetrafluoroethane (HFC-134a), pentafluoroethane (HFC-125), perfluoroethane, 2,2-difluoropropane (HFC-272fb), 1,1,1-trifluoropropane (HFC-263fb), 1,1,1,2,3,3,3-heptafluoropropane (HFC-227ea), 1,1,1,3,3-pentafluoropropane (HFC-245fa), and 1,1,1,3,3-pentafluorobutane (HFC-365mfc)); fully and partially halogenated polymers and copolymers, desirably fluorinated polymers and copolymers, even more preferably chlorine-free fluorinated polymers and copolymers; aliphatic alcohols having from one to five carbons such as methanol, ethanol, n-propanol, and isopropanol; carbonyl containing compounds such as acetone, 2-butanone, and acetaldehyde; ether containing compounds such as dimethyl ether, diethyl ether, methyl ethyl ether; carboxylate compounds such as methyl formate, methyl acetate, ethyl acetate; carboxylic acid and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate.

The amount of blowing agent can be determined by one of ordinary skill in the art without undue experimentation for a given thermoplastic to be foamed based on the type thermoplastic polymer, the type of blowing agent, the shape/configuration of the foam article, and the desired foam density. Generally, the foam article may have a density of from about 16 kilograms per cubic meter (kg/m³) to about 200 kg/m³ or more. The foam density, typically, is selected depending on the particular application. Preferably the foam density is equal to or greater than about 16 kg/m³, more preferably equal to or greater than about 21 kg/m³, and most preferably equal to or greater than about 26 kg/m³. Preferably the foam density is equal to or less than about 160 kg/m³, more preferably equal to or less than about 120 kg/m³, and most preferably equal to or less than about 100 kg/m³.

The cells of the foam plank may have an average size (largest dimension) of from about 0.05 to about 5.0 millimeter (mm), especially from about 0.1 to about 3.0 mm, as measured by ASTM D-3576-98. Foam planks having larger average cell sizes, of especially about 1.0 to about 3.0 mm or about 1.0 to about 2.0 mm in the largest dimension, are of particular use when the foam fails to have a compressive balance of at least 0.4 as described in the following paragraph. The cells of the foam plank may have a monomodal size distribution, a bimodal size distribution (sometimes referred to as duel cell), or, in some cases, a trimodal cell size distribution.

The compressive strength of the foam is determined in accordance with industry standard test methods such as ASTM D1621 or modifications thereof. Moreover, the compressive strength of the foam is evaluated in three orthogonal directions, E, V and H, where E is the direction of extrusion, V is the direction of vertical expansion after it exits the extrusion die and H is the direction of horizontal expansion of the foam after it exits the extrusion die. These measured compressive strengths, C_{E}, C_{V} and C_{H}, respectively, are related to the sum of these compressive strengths, C_{T}, such that at least one of C_{E}/C_{T}, C_{V}/C_{T} and C_{H}/C_{T} (wherein one or more of these terms are referred to collectively as compressive balance), has a value of at least 0.40, preferably a value of at least 0.45 and most preferably a value of at least 0.50. When using such a foam, the pressing direction is desirably parallel to the maximum compressive balance in the foam.

The polymer used to make the foam article of the present invention may contain additives, typically dispersed within the continuous matrix material. Common additives include any one or combination of more than one of the following: infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); fillers such as glass or polymeric fibers or glass or polymeric beads; flame retardants (for example, brominated flame retardants such as brominated polymers, hexabromocyclododecane, phosphorous flame retardants such as triphenylphosphate, and flame retardant packages that may including synergists such as, or example, dicumyl and polycumyl); lubricants (for example, calcium stearate and barium stearate); acid scavengers (for example, magnesium oxide and tetrasodium pyrophosphate); UV light stabilizers; thermal stabilizers; and colorants such as dyes and/or pigments.

As per convention, but not limited by, the extrusion of the plank is taken to be horizontally extruded (the direction of extrusion is orthogonal to the direction of gravity). Using such convention, the plank's top surface is that farthest from the ground and the plank's bottom surface is that closest to the ground, with the height of the foam (thickness) being orthogonal to the ground when being extruded.

To facilitate the shape retention and appearance in the shaped foam article after pressing the shaped foam plank, particularly foams comprising closed cells, it is desirable that the average gas pressure is equal to or less than 1.4 atmospheres. In one embodiment, it is desirable that the gas cell pressure is equal to or less than atmospheric pressure to minimize the potential for spring back of the foam after pressing causing less than desirable shape retention. Preferably, the average pressure of the closed cells (i.e., average closed cell gas pressure) is equal to or less than 1 atmosphere, preferably equal to or less than 0.95 atmosphere, more preferably equal to or less than 0.90 atmosphere, even more preferably equal to or less than 0.85 atmosphere, and most preferably equal to or less than 0.80 atmosphere.

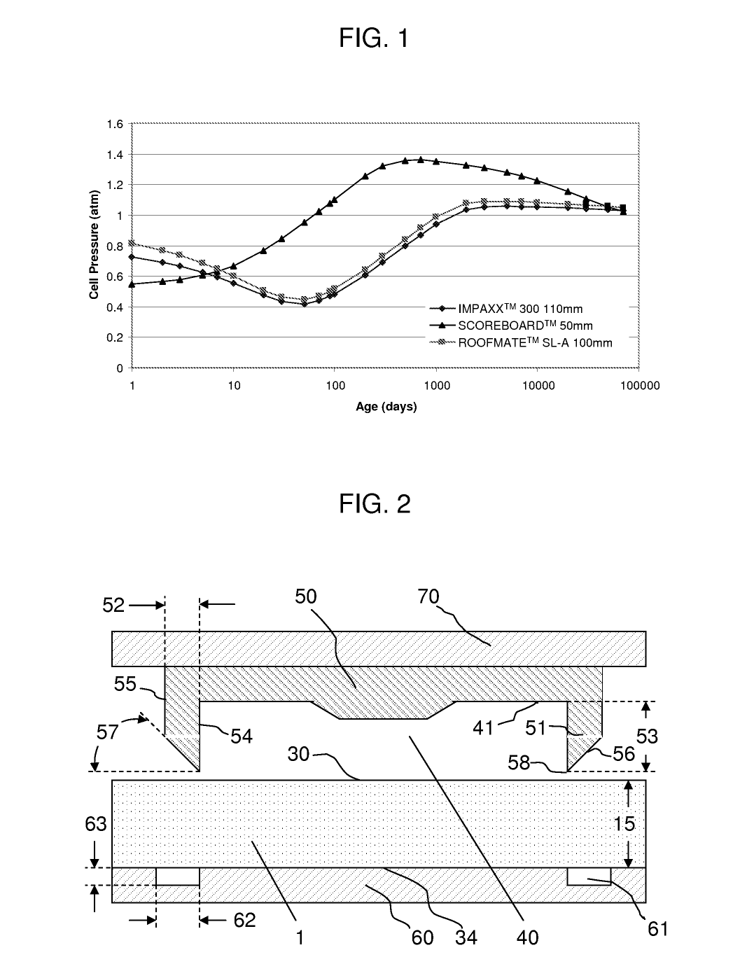

Unless otherwise noted, cell gas pressures herein are determined from standard cell pressure vs. aging curves, see FIG. 1. Alternatively, cell gas pressure can be determined according to ASTM D7132-05 if the initial time the foam is made is known. If the initial time the foam is made is unknown, then the following alternative empirical method can used: The average internal gas pressure of the closed cells from three samples is determined on cubes of foam measuring approximately 50 mm. One cube is placed in a furnace set to 85° C. under vacuum of at least 1 Ton or less, a second cube is placed in a furnace set to 85° C. at 0.5 atm, and the third cube is placed in the furnace at 85° C. at atmospheric pressure. After 12 hours, each sample is allowed to cool to room temperature in the furnace without changing the pressure in the furnace. After the cube is cool, it is removed from the furnace and the maximum dimensional change in each orthogonal direction is determined. The maximum linear dimensional change is then determined from the measurements and plotted against the pressure and curve fit with a straight line using linear regression analysis with average internal cell pressure being the pressure where the fitted line has zero dimensional change.

After the foam plank 1 is formed, a pressing surface 30 is created. If the foam plank has one pressing surface, it is defined as the surface with the lowest density. If the foam plank has two pressing surfaces, then the density of the first and second pressing surface may be the same or different as long as both pressing surfaces have a lower density than the center, or core, of the foam plank. A pressing surface may be formed, for example by removing a layer from the top or bottom surface or cutting the foam plank between the top and bottom surface to create two pressing surfaces opposite the top and bottom surface. Suitable methods that may be useful are cutting using equipment such as band saws, computer numeric controlled (CNC) abrasive wire cutting machines, CNC hot wire cutting equipment, laser cutting, water jet cutting, high-pressure fluid cutting, air guns and the like. When removing a layer, the same cutting methods just described may be used and other methods such as planing, grinding or sanding may be used.

Typically, after the removing or cutting, the plank is at least about several millimeters thick to at most about 60 centimeters thick. Generally, when removing a layer, the amount of material is at least about a millimeter and may be any amount useful to perform the method such as 1.2, 1.4, 1.6, 1.8, 2, 2.5, 3, 3.5, 4, 5 millimeters or any subsequent amount determined to be useful such as an amount to remove any skin (i.e., outer surface or top and bottom surface) that is formed as a result of extruding the thermoplastic foam, but is typically no more than 10 millimeters. In another embodiment, the foam is cut and a layer is removed from the top or bottom surface opposite the cut surface to form two pressing surfaces.

In a particular embodiment, the foam plank 1 having a pressing surface 30, has a density gradient from the pressing surface to the opposite surface of the foam plank 34. Generally, it is desirable to have a density gradient of at least 5 percent, 10 percent, 15 percent, 25 percent, 30 percent or even 35 percent from the pressing surface to the opposing surface of the foam plank. To illustrate the density gradient, if the density of the foam at the pressing surface (i.e., within a millimeter or two of the surface) is 3.0 pounds per cubic foot (pcf), the density would be for a 10 percent gradient either 2.7 or 3.3 pcf at the center of the foam. Likewise, if the foam plank has two pressing surfaces (a first pressing surface and a second pressing surface), both surfaces desirably have the aforementioned density gradient, in other words, the core of the foam has a higher density than the two pressing surfaces. Further, the density of the first pressing surface may be the same as the density of the second pressing surface or the density of the first pressing surface may be different than the density of the second pressing surface. In other words, preferably the pressing surface of the foam plank 30 for use in the method of the present invention has a lower density than opposite surface of the plank 34.

In the shaping/trimming step of the present invention, the surface of the foam plank opposite the pressing surface(s) of the foam plank is placed on a stationary forming surface, such as a stationary platen 60. A movable platen 70 which can move toward or away from the stationary platen on which the plank is placed comprises a forming tool 50 such as a single cavity mold or preferably a multiple cavity mold. To shape the foam, the movable platen moves towards the stationary platen such that the pressing surface(s) of the plank 30 is contacted and pressed with the mold 50. Herein mold means any tool having one (single-cavity) or a plurality (multi-cavity) of impressed shape(s) that when pressed into the foam plank will cause the foam to take the shape(s) of the mold cavity(ies). That is, the material making up the mold is such that it does not deform when pressed against the foam plank, but the foam plank deforms to form and retain the desired shape of the mold. For a multi-cavity mold, each cavity may be identical in shape or there may be as many different shapes as cavities or there may be a combination of multiple cavities with the same first shape in combination with multiple cavities with one or more shapes different than the first shape. The layout of cavities in a multi-cavity mold may be side by side, in tandem, or any other desirable configuration. A multi-cavity mold produces more than one shaped article in a plank per molding cycle.

Each cavity 40 of the mold 50 on the movable platen 70 is defined by a trimming rib 51 with a thickness 52, a height 53, an inside surface 54, an outside surface 55, and a trimming end 56. It is the rib inside surface 54, or the inner perimeter of the trimming rib, that defines the outline of the cavity. The trimming rib separates the shaped foam article 10 from the surrounding continuous unshaped foam plank 16.

The thickness 52 of the trimming rib 51, is equal to or greater than about 0.05 inches, preferably equal to or greater than about 0.13 inches, more preferably equal to or greater than about 0.25 inches, and most preferably equal to or greater than about 0.38 inches. The thickness 52 of the trimming rib 51, is equal to or less than about 1 inch, preferably equal to or less than about 0.75 inches, more preferably equal to or less than about 0.63 inches, and most preferably equal to or less than about 0.5 inch.

The trimming end 56 of the rib may have any configuration which satisfactorily trims the foam, preferably the trimming end of the rib is beveled towards or away from the cavity it surrounds, most preferably the bevel is towards the cavity. In other words, the furthest point of the trimming end of the trimming rib 58 defines the outline of the cavity. When the end of the trimming rib is beveled, the angle of the bevel 57 is greater than 0°, preferably equal to or greater than about 5°, preferably equal to or greater than about 10°, preferably equal to or greater than about 20°, and most preferably equal to or greater than about 30°. When the end of the trimming rib is beveled, the angle of the bevel 57 is less than 90°, preferably equal to or less than about 80°, preferably equal to or less than about 70°, and most preferably equal to or less than 60°.

The trimming rib height 53 is the distance from the inside surface of the cavity adjacent to the trimming rib 41 to the furthest point 58 of the trimming end 56 of the trimming rib 51.

A useful parameter is the final distance from the surface of the stationary forming surface on which the foam plank is placed to the corresponding inside surface of the cavity when the movable platen is in its closest proximity to the stationary platen during the molding cycle. Depending on the shape of the shaped foam article, there may be one or more final distance within a cavity, for example 17 and 18. If there is more than one final distance, the one with the greatest value is defined as the maximum final distance 17 and the one with the smallest value is defined as the minimum final distance 18. The final distance(s) will describe the thickness of the shaped foam article as molded 10 prior to elastic recovery of the foam, if any.

We have found that the ratio of the trimming rib height (hᵣ) to the minimum final distance (d_{f min}) hᵣ/d_{f min} is preferably equal to or greater than about 90 percent, more preferably equal to or greater than about 100 percent, and most preferably equal to or greater than about 110 percent. We have found that the ratio of the trimming rib height to the minimum final distance hᵣ/d_{f min} is preferably equal to or less than about 200 percent, more preferably equal to or less than about 150 percent, and most preferably equal to or less than about 125 percent.

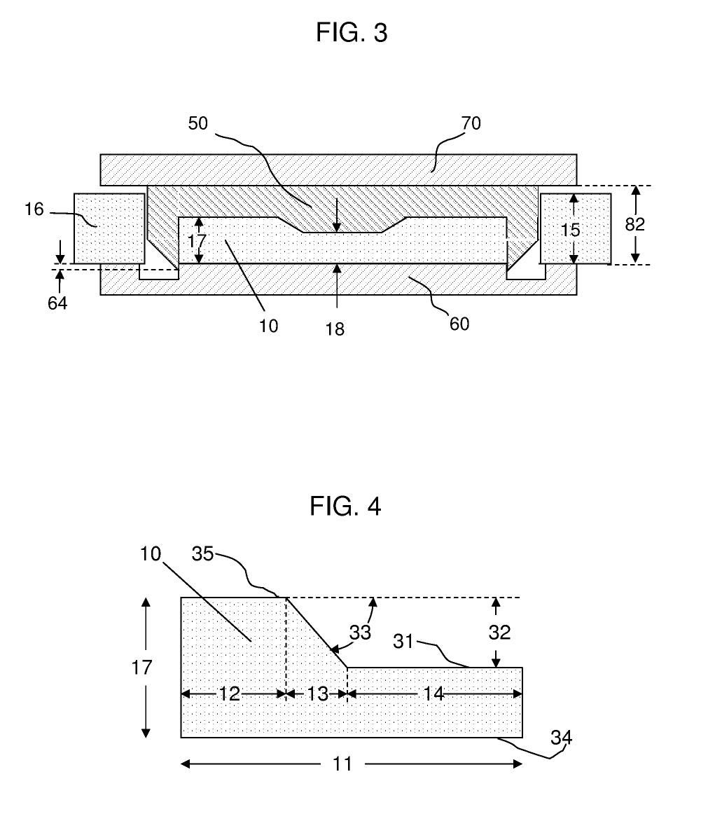

The stationary forming surface on which the foam plank is placed prior to shaping/trimming step is typically a stationary platen 60, however in one embodiment, the stationary platen may comprise a holding or aligning means for the foam plank or a forming tool, such as a mold paired with the mold on the movable platen, or the like. Preferably, the trimming rib does not contact the stationary forming surface, e.g., the stationary platen, holding or aligning means, forming tool, and/or mold. The stationary forming surface may comprise one or a plurality of grooves 61, each groove independently having a width 62 and a depth 63. Said groove(s) 61 align with the corresponding trimming rib(s) 51 of each cavity 40 in the forming tool 50 on the movable platen 70 such that when the movable platen is moved towards the stationary platen, the trimming rib may extend into its corresponding groove in the stationary forming surface, see FIG. 3. The groove(s) need not be any wider and/or deeper than necessary than what is required to allow for full, unimpeded penetration of the trimming rib when the movable platen 70 is positioned in its closest proximity 82 to the stationary platen 60 during the molding cycle.

The width of the groove, 62, is equal to or greater than about 101 percent of the trimming rib thickness 52, preferably equal to or greater than about 105 percent of the trimming rib thickness 52, preferably equal to or greater than about 110 percent of the trimming rib thickness 52, preferably equal to or greater than about 115 percent of the trimming rib thickness 52, and most preferably equal to or greater than about 120 percent of the trimming rib thickness 52. The width of the groove, 62, is equal to or less than about 200 percent of the trimming rib thickness 52, preferably equal to or less than about 175 percent of the trimming rib thickness 52, preferably equal to or less than about 150 percent of the trimming rib thickness 52, preferably equal to or less than about 135 percent of the trimming rib thickness 52, and most preferably equal to or greater than about 125 percent of the trimming rib thickness 52.

The minimum depth of the groove (d_{g min}) 64, is equal to the difference between the height of the trimming rib (hᵣ) 53 minus the distance the inside surface of the cavity adjacent to the trimming rib is from the stationary platen (d_{isc}) 17 when the movable platen is in its closest proximity during the molding cycle 82, d_{g min}≧hᵣ−d_{isc}. The depth of the groove (d_{g}) 63, is preferably equal to or greater than about 101 percent of d_{g min}, preferably equal to or greater than about 105 percent of d_{g min}, preferably equal to or greater than about 110 percent of d_{g min}, preferably equal to or greater than about 115 percent of d_{g min}, and most preferably equal to or greater than about 120 percent of d_{g min}. The depth of the groove, d_{g}, is equal to or less than about 200 percent of d_{g min}, preferably equal to or less than about 175 percent of d_{g min}, preferably equal to or less than about 150 percent of d_{g min}, preferably equal to or less than about 135 percent of d_{g min}, and most preferably equal to or greater than about 125 percent of d_{g min}.

In one embodiment of the present invention (not illustrated in the drawings), the groove 61 passes completely through the stationary platen.

We have found that the velocity at which the movable platen presses the foam plank is preferably equal to or greater than about 2 inches per minute (in/min), more preferably equal to or greater than about 6 in/min, and most preferably equal to or greater than about 12 in/min. We have found that the velocity at which the movable platen presses the foam plank is preferably equal to or less than about 120 in/min, more preferably equal to or less than about 60 in/min, and most preferably equal to or less than about 35 in/min.

Typically when pressing, at least a portion of the foam is pressed such that the foam is compressed to a thickness of 95 percent or less of the to be pressed foam thickness 15 as shown in FIG. 2, which typically corresponds to just exceeding the yield stress of the foam. Likewise, when pressing the part, the maximum deformation of the foam (elastically deforming the foam) is typically no more than about 20 percent of the original thickness 15 of the foam ready to be pressed.

The forming tool such as a mold, because a shape is most often desired, typically has contours that create an impression (step change) in height 32 of at least a millimeter (mm) in the shaped foam article 10 having thickness 17 as shown in FIG. 4. The height/depth 32 of an impression may be measured using any suitable technique such as contact measurement techniques (e.g., coordinate measuring machines, dial gauges, contour templates) and non-contact techniques such as optical methods including laser methods. The height of the step change 32 may be greater than 1 millimeter such as 1.5, 2, 2.5, 3, 3.5, 4, 5, 6, 7, 8, 9 and 10 to a height that is to a point where there are no more foam cells to collapse such that pressing further starts to elastically deform the plastic (polymer) of the foam.

The step change, surprisingly, may be formed where the foam undergoes shear. For example, the foam may have a shear angle 33 of about 45° to about 90° from the pressing surface 35 to the pressed surface 31 of the shaped foam article 10 in a step change 32. It is understood that the shear angle may not be linear, but may have some curvature, with the angle in these cases being an average over the curvature. The angle surprisingly may be greater than 60°, 75° or even by 90° while still maintaining an excellent finish and appearance.

In another aspect of the invention, a thermoplastic foam having a higher concentration of open cells at a surface of the foam than the concentration of open cells within the foam is contacted and pressed to form the shape. In this aspect of the invention the foam may be any thermoplastic foam such as the extruded styrenic polymer foam described above. It may also be any other styrenic polymeric foam such as those known in the art.

With respect to this open cell gradient, the gradient is the gradient where the concentration of open cells if determined microscopically and is the number of open cells per total cells at the pressing surface (cut or planed) compared to the number of open cells per total cells at the core of the foam or the other as received surface (i.e., skin surface), whichever comparison (core or other as received surface) provides the greatest gradient value. Preferably, the open cell gradient is equal to or less than 50 percent, more preferably it is equal to or less than 45 percent, more preferably it is equal to or less than 40 percent, more preferably it is equal to or less than 35 percent, more preferably it is equal to or less than 30 percent, more preferably it is equal to or less than 25 percent, more preferably it is equal to or less than 20 percent, more preferably it is equal to or less than 15 percent, more preferably it is equal to or less than 10 percent, or most preferably is equal to 5 percent.

Generally, the amount of open cells in this aspect of the invention at the surface is at least 5 percent to completely open cell. Desirably, the open cells at the surface is at least in ascending order of 6 percent, 7 percent, 8 percent, 10 percent, 20 percent, 30 percent, 40 percent, 50 percent, 60 percent, 70 percent, 80 percent, 90 percent and completely open cell at the surface.

The foam may have the open cells formed at the surface by mechanical means such as those described above (e.g., planing, machining, cutting, etc.) or may be induced chemically, for example, by use of suitable surfactants to burst closed cells at the surface.

The foam surface with the higher concentration of open cells is contacted with a mold and pressed as described above. In one embodiment for such foams, the mold may be heated, but the foam is not (ambient 15-30° C.) and the foam plank is pressed. Surprisingly, the heating the mold results in superior surface contour and appearance, whereas when doing the same with a foam plank without such open cells at the surface, the appearance of the foam is degraded.

When pressing with a heated forming tool such as a mold, the contact time with the foam is typically from about 0.1 second to about 60 seconds. Preferably, the dwell time is at least about 1 second to at most about 45 seconds.

When pressing with a heated forming tool such as a mold, the temperature of the mold is not so hot or held for too long a time such that the foam is degraded. Typically, the temperature of the mold is about 50° C. to about 200° C. Preferably, the temperature is at least about 60°, more preferably at least about 70° C., even more preferably at least about 80° C. and most preferably at least about 90° C. to preferably at most about 190°, more preferably at most about 180°, even more preferably at most about 170° C. and most preferably at most about 160° C. For example, for a styrenic foam the mold is preferably at a temperature equal to or greater than 60° C., more preferably equal to or greater than 80° C., and most preferably equal to or greater than 90° C.

In the method of the present invention the foam plank may be heated prior to shaping. Suitable temperatures will depend on the composition of the foam as well as its thickness. Preferably, the foam plank in the present method is shaped at ambient temperature.

Not to be held to any particular theory, we believe that the combination of preferable cell morphology, blowing agent, surface density, and open cell gradient through the foam plank facilitate local buckling when shaping the pressing surface allows for ductile buckling of the cell morphology resulting in the foam retaining the desired shape with an acceptable (e.g., low) level of compressive recovery.

The shaped foam article may be perforated by any acceptable means. The shaped foam article may have a plurality of perforations. The perforations extend partially through and/or completely through the shaped foam article, for instance for a shaped foam article made from a foam plank, the perforations may extend completely through the depth of the foam plank so as to allow a vacuum to be pulled through the shaped foam article. Perforating the foam article may comprise puncturing the foam article with a one or more of pointed, sharp objects in the nature of a needle, pin, spike, nail, or the like. However, perforating may be accomplished by other means than sharp, pointed objects such as drilling, laser cutting, high-pressure fluid cutting, air guns, projectiles, or the like. The perforations may be made in like manner as disclosed in U.S. Pat. No. 5,424,016, which is hereby incorporated by reference.

The depth of the shaped feature(s) may be between 2 to 80 percent of the original compressed depth more preferably equal to or greater than 4 percent, more preferably greater than 8 percent and most preferably greater than 10 percent of the original compressed depth.

The shaped foam article of the present invention is a shaped foam article which is prepared from a foamed plank as described hereinabove and further shaped by a forming tool to give a shaped foam article. As defined herein, shaped means the foamed article typically has one or more contour that create a step change (impression) in height 32 of at least 1 millimeter or more in the shaped foam article 10 having thickness 17 as shown in FIG. 4. A shaped foam article has at least one surface that is not planar. The shape of the foam article is only limited by the ability to shape foam plank. One or both surfaces (i.e., top and bottom) of the foam plank may be shaped. Examples of shapes are a groove, a corrugation, a sinusoid, or any other three-dimensional surface feature.

In one embodiment of the present invention, the shaped foam article may comprise one or more through feature, e.g., one or more hole through the shaped foam article. The perimeter of each through feature is defined by through feature trimming ribs. The through feature may have any geometric shape which can be defined by through feature trimming ribs, for example, but not to be limited to, the through feature may be round, egg-shaped, oval, triangular, square, rectangular, trapezoidal, five-sided, six-sided, seven-sided, eight-sided, star-shaped, irregular-shaped, etc. Examples of a shaped foam articles with a through feature are a shower base with a hole for a drain, an automobile headliner with a square hole for a lighting fixture, a shake shingle roofing panel with a hole for a vent, etc. Each cavity of the mold that forms a shaped form article comprising one or more through feature will contain one or more set of through feature trimming ribs which define the perimeter of the through feature (i.e., one set of trimming ribs for each through feature, for example, set 1 for a circle, set 2 for a square, set 3 for a star, etc.).

Examples of shaped foam articles of the present invention are shaped foam articles for applications such as construction applications: siding, insulation sheathing, decorative trim, shingles, vinyl siding backing, integrated radiant floor heating panels, sandwich panels with non-planer faces; furniture applications; composite panels; foot wear; buoyancy parts for boats and watercraft; decoration products for craft applications; energy absorption applications, such as wherein only a portion of the formed article is require for impact energy absorption attenuation, for example an energy absorption component in an automotive articles such as headliner countermeasures, door energy absorbers, bumper inserts, knee bolsters, head rests; helmets; knee pads; military applications; and crash barriers; etc. Further, the shaped formed articles of the present invention can advantageously be used in packaging applications.

### EXAMPLES

The following foam planks are evaluated:

“IMPAXX™ 300 Foam Plank” is available from The Dow Chemical Co., Midland, Mich. This foam plank is an extruded polystyrene foam with dimensions measuring 110 mm by 600 mm by 2,200 mm in the thickness, width and length directions respectively having a density of 36 kilograms per cubic meter (kg/m³) and 5 millimeter (mm) to 7 mm of the surface to be formed is removed by planing. The polystyrene has a weight average molecular weight of 146,000, the blowing agent is CO₂, and the cell gas pressure is about 0.6 atmospheres (atm).

“ROOFMATE™ SL-A Foam Plank” is available from The Dow Chemical Co., Midland, Mich. This foam plank is an extruded polystyrene foam with dimensions measuring 100 mm by 600 mm by 1250 mm in the thickness, width and length directions respectively having a density of 32 kg/m³ and the surface to be formed contains the skin from the manufacturing process (i.e., not planed). The polystyrene has a weight average molecular weight of 150,000, the blowing agent is CO₂/isobutane and the cell gas pressure is about 0.6 atm.

“SCOREBOARD™ Foam Plank” is available from The Dow Chemical Co., Midland, Mich. This foam plank is an extruded polystyrene foam with dimensions measuring 51 mm by 1220 mm by 2440 mm the thickness, width and length directions, respectively, having a density of 25 kg/m³ and the surface to be formed contains the skin from the manufacturing process (i.e., not planed). The polystyrene has a weight average molecular weight of 168,000, the blowing agent is HCFC-142b, and the cell gas pressure is about 1.4 atm.

The following properties of the foam planks are summarized in Table 1:

“Rv” vertical compressive balance is determined on three replicate tests specimens having a thickness, t (in units of inches), aligned in the vertical (V), horizontal (H) and extrusion (E) direction of the board respectively. Each specimen was compressed at a strain rate, dε/dt, of approximately 0.065 s⁻¹ using a Materials Test System equipped with a 5.0-inch displacement card and a 4,000 pound load card. A 458.91 MicroProfiler was used to program the velocity and displacement of the platens in both loading as well as unloading. For each series of tests, the crosshead velocity, Cv (in units of in/min), is determined from the following equation:

$$Cv = 60 \cdot t \cdot \frac{d ɛ}{d t}$$

The crosshead displacement, Δt (in units of inches), is calculated to subject each series of test specimens to a compressive strain of approximately 65 percent as shown in the following equation:

$$Δ t = \frac{ɛ \cdot {t}_{o}}{100}$$

whereby tₒ denotes the original thickness of the test specimen as measured by a linear digital gage. Finally, the return rate (in units of in/min) is programmed such that when the crosshead had reached the programmed displacement (i.e. Δt), the moving platen would unload at the same crosshead velocity during loading.

Prior to testing, the specimen dimensions, in units of inches, are measured in each respective direction (i.e. V, E & H) and the sample mass, M (in units of grams), is recorded using a gravimetric balance. The specimen density, in units of kilograms per cubic meter (kg/m³), is then computed from the following equation:

$$Density = 61.0237 \cdot ( \frac{M}{V \cdot E \cdot H} )$$

The mean density for each foam product is recorded hereinabove.

The compressive strength, CS, of each test specimen is computed in accordance with the procedure detailed in ASTM D1621, “Standard Test Method for Compressive Properties of Rigid Cellular Plastics”. The compressive balance, R, in each direction of the board (i.e. R_{V}, R_{H} & R_{E}) is computed from the following equations:

R_{V}=CS_{V}/CS_{T}

R_{H}=CS_{H}/CS_{T}

R_{E}=CS_{E}/CS_{T}

whereby CS_{T} denotes the total compressive strength calculated in accordance with the following equation:

CS_{T}=CS_{V}+CS_{H}+CS_{E};

“Density Gradient” is the density profile through the thickness of each foam plank measured using a QMS Density Profiler, model QDP-01×, from Quintek Measurement Systems, Inc. Knoxville, Tenn. The High Voltage kV Control is set to 90 percent, the High Voltage Current Control was set to 23 percent and the Detector Voltage was approximately 8 volts. Data points are collected every 0.06 mm throughout the thickness of the foam. Mass absorption coefficients were calculated for each sample individually, based on the measured linear density of the foam part being tested. The skin density, ρₛₖᵢₙ, is reported as a maximum value whereas the core density, ρ_{core}, is averaged within an approximate 5 mm range of the center of the plank. The density gradient, in units of percentage, is computed in accordance with the following equation:

$$Density Gradient ( \% ) = 100 \cdot \frac{( {ρ}_{core} - {ρ}_{skin} )}{{ρ}_{skin}} ;$$

“Open Cell Content” as determined by ASTM D6226 and measured using an Archimedes method on a 25 mm by 25 mm by 50 mm foam sample and the value is reported as mean open cell content in percent; and

“Cell Gas Pressure” is determined from standard cell pressure vs. aging curve, see FIG. 1.

TABLE 1

| | | Density | Open Cell | Cell Gas |
|---|---|---|---|---|
| Foam Sample | Rv | Gradient, % | Content, % | Pressure, atm |
| IMPAXX 300 | 0.59 | −18.6 | 4.9 | 0.6 |
| ROOFMATE SL-A | 0.48 | −24.2 | 0.9 | 0.6 |
| SCOREBOARD | 0.33 | −28.4 | 3.6 | 1.4 |

Each Foam Plank is cut to render a foam blank measuring approximately 10 in by 6 in by 2 in, in the length, width and thickness directions respectively. Examples 1 to 3 are foam blanks for IMPAXX 300, ROOFMATE SL-A, AND SCOREBOARD, respectively. The planed or skin surface of the foam blank is then compressed against the surface of an aluminum compression fixture having a cavity in the shape of a rectangle measuring 8 in long by 4 in wide and whereby the periphery of the cavity is defined by a trimming rib measuring about 0.38 in wide and about 1.125 in long. The fixture is mounted to the movable platen of a MTS 810 Material Testing System. The MTS 810 is programmed for a crosshead velocity of 12 in/min and the foam sample is compressed 1.25 in (i.e., the movable platen is 0.75 in from the stationary platen). The angle of the bevel on the trimming ends of the trimming ribs is 40°. The stationary platen has a groove with a width of 0.4 in and a depth of 0.5 in.

The width and length of the resulting shaped foam articles are measured with CORDAX Optical Coordinate Measuring Machine (CMM). Parts placed orthogonal on flat surface and held in place. Spatial coordinates (X, Y) for each end (X_{right}, Y_{right} and X_{left}, Y_{left}) are determined and the maximum length is determined to be the difference between the greatest X_{right} value and the least X_{left} value. An acceptable tolerance for length, based on an automotive industry requirement for energy absorbing countermeasure parts, is +/−1 percent (%) based on the length of the mold cavity.

TABLE 1

| Example | Length, in | Tolerance, % | Acceptable |
|---|---|---|---|
| 1 | 8.0395 | 0.49 | yes |
| 2 | 8.0772 | 0.96 | yes |
| 3 | 9.5780 | 16.48 | no |

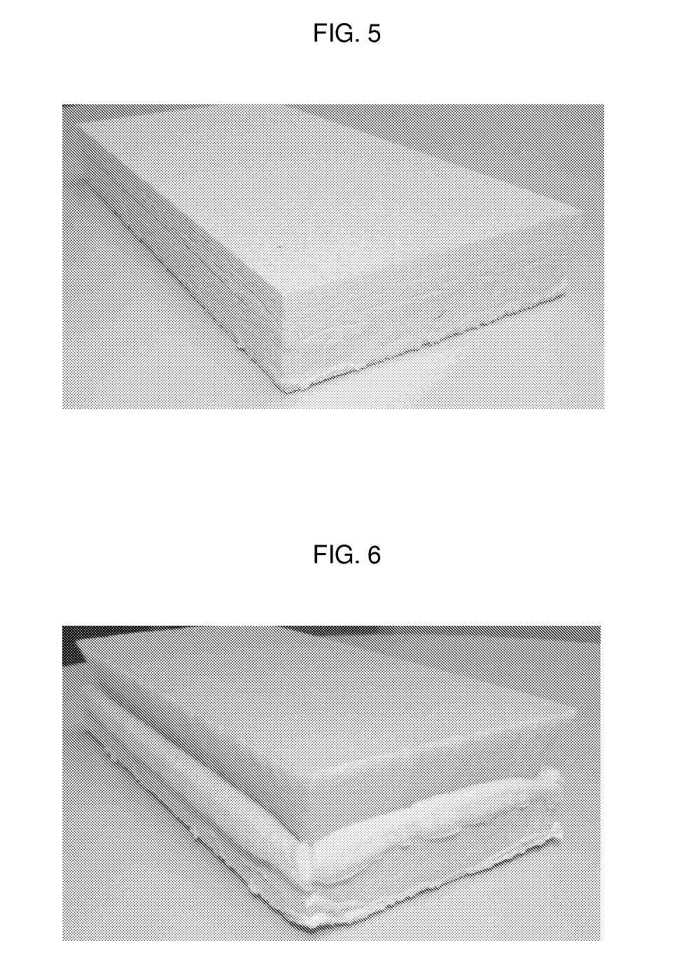

FIG. 5 is a copy of a photograph of Example 1. FIG. 6 is a copy of a photograph of Example 3. From FIG. 5 and FIG. 6, it can be seen that a shaped foam article of the present invention demonstrates superior dimensional control versus a shaped foam article that is not an example of the present invention.

1. A method to manufacture one or more shaped foam article comprising the steps of:
(i) extruding a polymer with a blowing agent to form a polymer foam plank, the plank having a thickness, a top surface, and a bottom surface in which said surfaces lie in the plane defined by the direction of extrusion and the width of the plank,
wherein the foam plank has
(i)(a) a vertical compressive balance equal to or greater than 0.4 and
(i)(b) one or more pressing surface;
(ii) concurrently shaping and trimming the one or more pressing surface of the foam plank into one or more shaped foamed article and surrounding continuous unshaped foam plank by
(ii)(a) contacting the pressing surface of the foam plank with a mold, said mold comprising one or a plurality of cavities wherein the periphery of each cavity is defined by a trimming rib
and
(ii)(b) pressing the foam plank with the mold whereby
(ii)(b)(A) forming one or more shaped foam article
and
(ii)(b)(B) trimming each shaped foam article thus formed from the surrounding continuous unshaped foam plank.

2. The method of claim 1 wherein the pressing surface is created by the step of
(i)(b)(1) removing a layer of foam at least 1 millimeter thick from the top surface, the bottom surface, or both the top and bottom surfaces
or
(i)(b)(2) cutting the foam plank between the top and the bottom surfaces creating two pressing surfaces opposite the top and bottom surfaces.

3. The method of claim 1 wherein the foam has a cell gas pressure equal to or less than 1 atmosphere.

4. The method of claim 1 wherein the foam plank is at ambient temperature during the shaping step.

5. The method of claim 1 wherein the polymer is a thermoplastic polymer selected from polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyvinyl chloride; polyphenylene oxide and polystyrene blend.

6. The method of claim 1 wherein the thermoplastic polymer is polystyrene or styrene and acrylonitrile copolymer.

7. The method of claim 1 wherein the blowing agent is a chemical blowing agent, an inorganic gas, an organic blowing agent, or combinations thereof.

8. The method of claims 1 and 7 wherein the blowing agent is carbon dioxide.

9. The method of claim 1 wherein the shaped foam article further comprises one or more through feature.

10. A shaped foam article made by the method of claim 1.

11. The shaped foam article of claim 10 is a foam trim, an automotive part, a decorative insulation, safety equipment, packaging material, formfit insulation, an insulated sheathing, an insulated building cladding, a decorative trim, a vinyl siding backing, an integrated radiant floor heating panel, a sandwich panel with non-planer faces, a composite panel, foot wear, a buoyancy part for boats or watercraft, a decoration product for a craft application, an energy absorption component in a helmet, an energy absorption component in a military application, an energy absorption component in an automotive article, a foam composite part for windmill turbine blades, composite roof tiles, or a cushion packaging article.
